(19) United States
(12) Patent Application Publication
(10) Pub. No.: US 2006/0239524 A1
(43) Pub. Date: Oct. 26, 2006

(54) Dedicated display for processing and analyzing multi-modality cardiac data

(76) Inventors: Vladimir Desh, Glenview, IL (US); Thomas O'Donnell, New York, NY (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/252,666

(22) Filed: Oct. 18, 2005

Related U.S. Application Data
(60) Provisional application No. 60/666,943, filed on Mar. 31, 2005.

(51) Int. Cl. G06K 9/00

(52) U.S. Cl. 382/128

(57) ABSTRACT

For diagnosis and treatment of cardiac disease, images of the heart muscle and coronary vessels are captured using different medical imaging modalities; e.g., single photon emission computed tomography (SPECT), positron emission tomography (PET), electron-beam X-ray computed tomography (CT), magnetic resonance imaging (MRI), or ultrasound (US). For visualizing the multi-modal image data, the data is presented using a technique of volume rendering, which allows users to visually analyze both functional and anatomical cardiac data simultaneously. The display is also capable of showing additional information related to the heart muscle, such as coronary vessels. Users can interactively control the viewing angle based on the spatial distribution of the quantified cardiac phenomena or atherosclerotic lesions.

### BACKGROUND OF THE INVENTION

1. Field of the Invention

The present invention relates generally to medical imaging, and more particularly to computer processing of cardiac image data for diagnosis and treatment of cardiac disease.

2. Description of the Background Art

Medical imaging is one of the most useful diagnostic tools available in modern medicine. Medical imaging allows medical personnel to non-intrusively look into a living body in order to detect and assess many types of injuries, diseases, conditions, etc. Medical imaging allows doctors and technicians to more easily and correctly make a diagnosis, decide on a treatment, prescribe medication, perform surgery or other treatments, etc. There are medical imaging processes of many types and for many different purposes, situations, or uses. They commonly share the ability to create an image of a bodily region of a patient, and can do so non-invasively. Examples of some common medical imaging types are nuclear medical (NM) imaging such as positron emission tomography (PET) and single photon emission computed tomography (SPECT), electron-beam X-ray computed tomography (CT), magnetic resonance imaging (MRI), and ultrasound (US). Using these or other imaging types and associated machines, an image or series of images may be captured. Other devices may then be used to process the image in some fashion. Finally, a doctor or technician may read the image in order to provide a diagnosis.

The existing displays for 3D medical imaging data acquired with different types of imaging equipment typically present three orthogonal 2D planes for two different modalities fused together. One of the benefits of presenting fused data is the ability to display anatomical and functional features simultaneously. For instance, fused CT and PET images are used in the oncological and neurological studies. Although proven to be quite useful, this technique does not allow users to view fused volumes in 3D space. They may at best see three cross-sections rather than the region of interest as a whole. Another attempt to display multi-modality fused data has been done for cardiac images acquired with SPECT or PET and computed tomography angiography (CTA). The segmented endo- and epi-cardiac surfaces of the left ventricle (LV) are used to model 3D heart images, and coronaries segmented from the CTA volumes are superimposed on the model images in 3D space. One of the important features of this approach is color-coding of the left ventricle (LV) surfaces indicating level of the cardiac muscle perfusion or viability. Another advantage for this type of display is that the user can simultaneously access LV perfusion or viability defects together with corresponding feeding coronaries. The main disadvantage of this approach is that it operates with the modeled, not actual heart images. This abstracts the heart and takes it out of anatomical context.

### SUMMARY OF THE INVENTION

In accordance with a basic aspect, a multi-modality cardiac display provides visualization of cardiac perfusion and viability defects using actual volume rendered images. At the same time the user has the ability to analyze anatomical structure of the heart and coronary vessels also rendered from the actual images and fused together.

In accordance with one aspect, the invention provides a computer-implemented method including the step of obtaining cardiac image measurements of a patient from different imaging modalities to obtain volume image data of cardiac functional features from one imaging modality and volume image data of cardiac structural features from another imaging modality. The method further includes displaying, to a human user, a fused volume rendered view of the volume image data of the cardiac functional features and the volume image data of the cardiac structural features.

In accordance with another aspect, the invention provides a system including a digital computer and a display coupled to the digital computer for display of image data processed by the digital computer. The digital computer is programmed for obtaining cardiac image measurements of a patient from different imaging modalities to obtain volume image data of cardiac functional features from one imaging modality and volume image data of cardiac structural features from another imaging modality. The digital computer is further programmed for controlling the display for displaying, to a human user, a fused volume rendered view of the volume image data of the cardiac functional features and the volume image data of the cardiac structural features.

In accordance with still another aspect, the invention provides a system including a digital computer and a display coupled to the digital computer for display of image data processed by the digital computer. The digital computer is programmed for obtaining cardiac image measurements of a patient from a nuclear medicine (NM) scanner to obtain volume image data of cardiac perfusion and viability and obtaining cardiac image measurements of the patient from at least one of an X-ray computed tomography (CT) scanner or a magnetic resonance imaging (MR) scanner to obtain volume image data of cardiac structural features including coronary arteries. The digital computer is also programmed for automatically analyzing the volume image data of the cardiac structural features to identify the coronary arteries, and for registering the volume image data of cardiac perfusion and viability with the volume image data of the cardiac structural features. The digital computer is further programmed for controlling the display for displaying, to a human user, a fused volume rendered view of the registered volume image data of the cardiac perfusion and viability and the volume image data of the cardiac structural features, and for displaying the coronaries and the volume image data of cardiac perfusion and viability in distinctive colors in the fused volume rendered view.

The above and other features and advantages of the present invention will be further understood from the following description of the preferred embodiments thereof, taken in conjunction with the accompanying drawings.

### BRIEF DESCRIPTION OF THE DRAWINGS

FIG. 1 is a block diagram of a system for medical imaging and computer-implemented diagnosis and treatment of cardiac disease;

FIG. 2 shows a fused volume rendered view of a patient's heart;

FIG. 3 is a flow diagram of the production of a fused volume rendered view from multi-modality image data in the system of FIG. 1; and

FIG. 4 shows a typical clinical workflow using the dedicated cardiac display for multi-modality data in the system of FIG. 1.

### DETAILED DESCRIPTION OF THE PREFERRED EMBODIMENTS

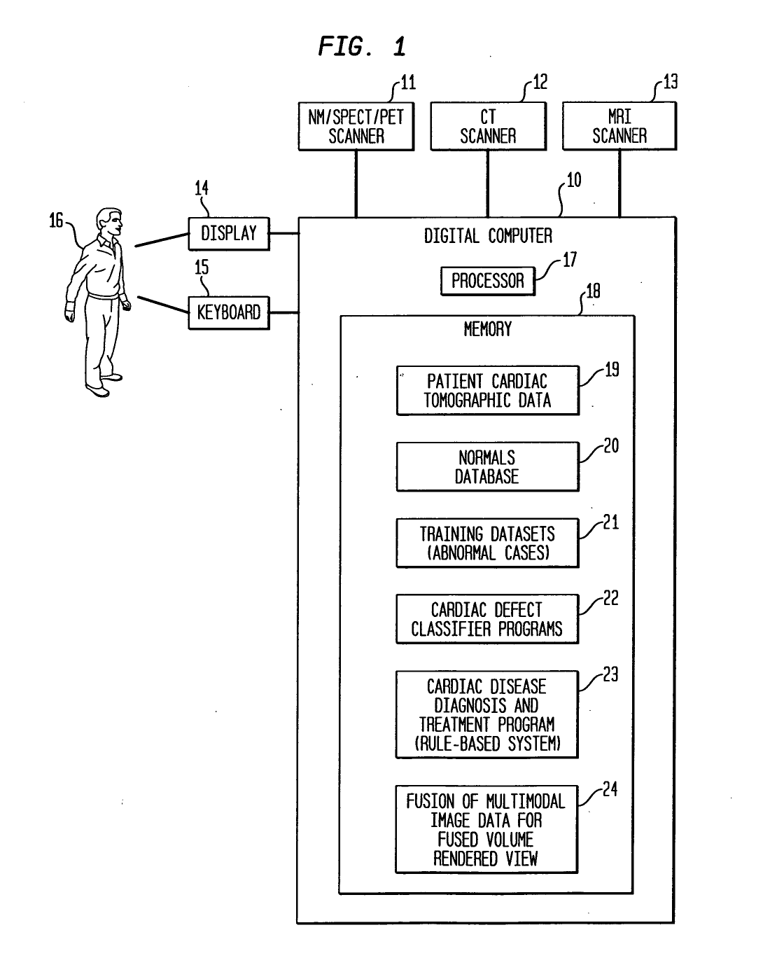

FIG. 1 shows a system for medical imaging and computer-implemented diagnosis and treatment of cardiac disease. The system includes a digital computer 10 and an NMISPECT/PET scanner 11, a CT scanner 12, and an MRI scanner 13. Additional scanners may be used, such as an ultra-sound (US) scanner. The computer 10 is linked to a display 14 and a keyboard 15 to provide an interface to a human user 16. The computer includes a processor 17 and a memory 18. The memory 18 stores a database 19 of patient cardiac tomographic data from the scanners 11, 12, 13; a normals database 20 of cardiac measurements of healthy patients, and a database 21 of training datasets including abnormal cardiac measurements from patients having cardiac disease. The memory 18 also stores cardiac defect classifier programs 22 for identifying cardiac defects in a patient from the patient cardiac tomographic data 19, and a rule-based cardiac disease diagnosis and treatment program 23 for diagnosing and treating cardiac disease based on cardiac defects identified by the cardiac defect classifier programs.

The cardiac defect classifier programs 22 and the cardiac disease diagnosis and treatment program 23 can be similar to widely accepted commercial software for cardiac studies in nuclear medicine, such as the Emory Cardiac Toolbox (Trademark) brand of cardiac imaging software currently being distributed by ADAC Laboratories, ELGEMS, Marconi, Medimage, Siemens Medical Systems, and Toshiba. The Emory Cardiac Toolbox (Trademark) software, for example, includes programs for quantitative perfusion analysis, gated SPECT quantitative functional analysis, 3-D display of perfusion, expert systems analysis, prognostic evaluation, automatic derivation of visual scores, generic coronary artery fusion, PET/CT actual patient coronary fusion, normal limit generation, nuclear medicine data reporting, PET data reporting, quality control of gated SPECT studies, and display of stress and rest gated studies for two-dimensional slices and three-dimensional images.

In accordance with a basic aspect of the present invention, the cardiac imaging software in the memory 18 of the computer 10 includes a program 24 for fusion of multi-modal image data for presenting to the user 16 a fused volume rendered view on the display 14.

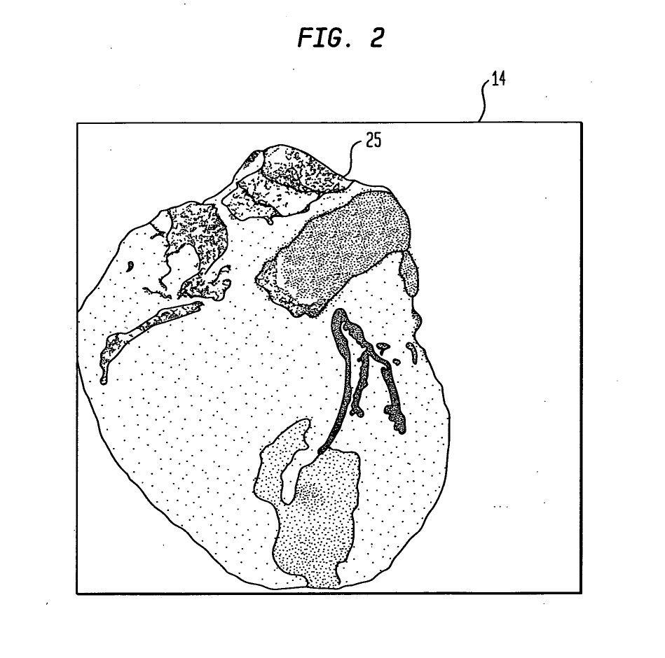

As shown in FIG. 2, for example, the fused volume rendered view depicts a patient's heart 25 on the screen of the display 14. In general, when the computer 10 operates the display 14 in a dedicated multi-modality cardiac display mode, the user is presented with one to three volumetric objects in a fused volume rendered view. The display accepts three volumes: NM (PET or SPECT), CT or MRI, and segmented coronaries. The segmented coronaries object is a segmented binary mask derived from the anatomical CTA or MRA volume. Segmentation may include the entire coronary tree or its portions; i.e., calcified or volumable plaques inside coronary vessels. The transparency of each volume as well as the color-coding schema is user-adjustable. By modifying fusion ratios, the user can see fused NMICT volumes, NM/Coronaries volumes, CT/Coronaries volumes, or all three (NM/CT/Coronaries) together. Segmented coronaries are shown in a single color, or in three colors including a respective color for each one of the three major vessels (left anterior descending artery, circumflex artery, and right coronary artery). The user also is able to rotate, pan, or zoom in on the fused volumes.

The input volumes can be registered and displayed in a blended fashion as given. Registration matrices can also be associated with the second or third volumes, in which case the volumes are aligned by applying the associated registration matrices prior to rendering. The registration matrix may be rigid body, affine, or a non-isotropic spatial transformation mapping corresponding voxels from different volumes to each other.

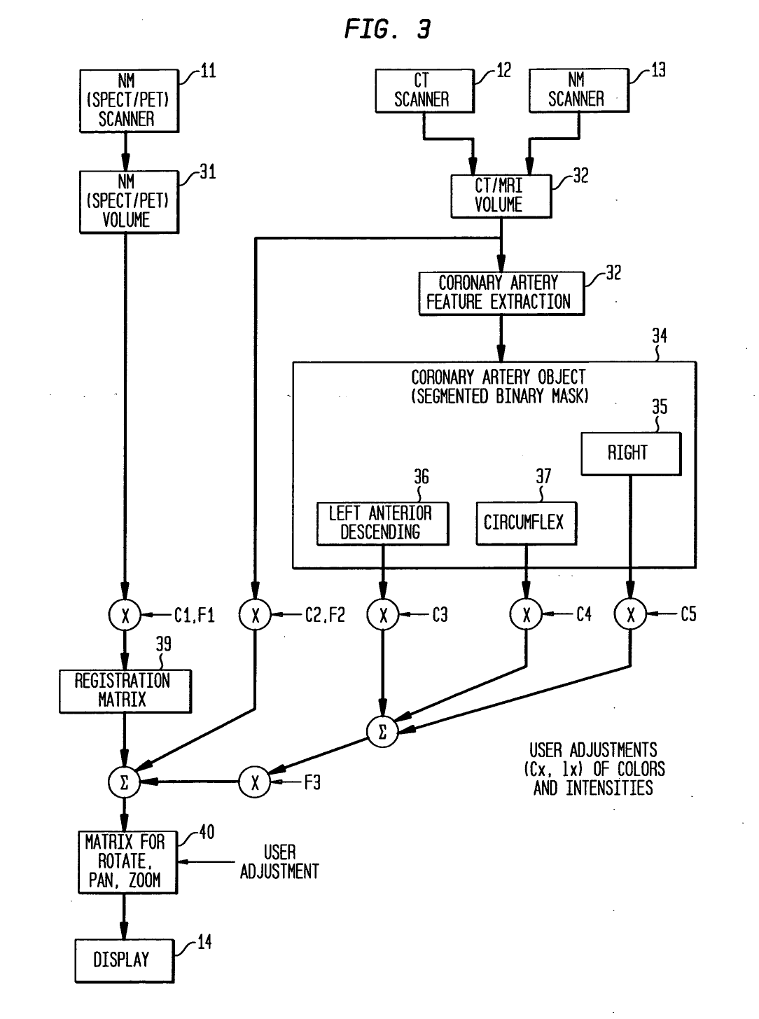

FIG. 3 shows the flow of data for the production of the fused volume rendered view on the display 14. The NM (SPECTIPET) volume 31 is comprised of three-dimensional coronary image data collected from the NM scanner 11, and the CT/MRI volume 32 is comprised of three-dimensional coronary image data collected from the CT scanner 12 or from the MRI scanner 13. A coronary artery feature extraction program 33 automatically identifies the voxels in the CT/MRI volume that correspond to the locations of the coronary arteries, and also identifies whether each of these voxels corresponds to the location of the right coronary artery 35 or the left anterior descending artery 36 or the circumflex artery 37. For example, a coronary artery object 34 in the form of a segmented binary bit mask can have two bits for each voxel of the CT/MRI volume 32, and the bits can be coded as follows: 00 binary indicates a voxel at which no coronary artery is present; 01 indicates a voxel at which the right coronary artery is present, 10 indicates a voxel at which the left anterior descending artery is present, and 11 indicates a voxel at which the circumflex artery is present.

There is a respective color adjustment (C1, C2) and a respective fusion ratio (F1, F2) for each of the NM and CT/MRI volumes 31, 32. There is also a respective fusion ratio (F3) for the coronary artery object 34 and a respective color adjustment (C3, C4, C5) for each of the three main coronary arteries. Default values are provided so that the coronary arteries and other features from the CT/MRI volume and features from the NM volume initially will be visible in the display, but the user may adjust these default values to emphasize or eliminate a particular one of the volumes or the coronary artery object from the fused image. For example, the user provides respective intensity adjustments (I1, I2, I3). When the intensity adjustment for a particular volume or the coronary artery object exceeds a mid-range value, this will suppress the features from the other volumes or coronary artery object. In other words, the respective fusion ratio for each of the coronary artery object 34 and the volumes 31, 32 is determined by the intensity adjustments so that the intensity adjustments may adjust the transparency of the respective coronary artery object or features from the respective NM volume or the respective CT/MRI volume.

For example, each color adjustment specifies a respective red, green, and blue value. Each intensity adjustment (I1, I2, I3) scales the corresponding fusion ratio (F1, F2, F3), and each fusion ratio scales the red, green, and blue values of the corresponding volume or coronary artery object. Moreover, when the user specifies an intensity adjustment for one of the volumes 31, 32 or the coronary artery object 34 that exceeds a mid-range value by a certain percentage, the fusion ratios for the other volumes or the coronary artery object are scaled down by this percentage. For example, each of the intensity adjustments (I1, I2, I3) ranges from 0 to 1 and has a default value of 0.5, and the fusion ratios (F1, F2, F3) are computed from the intensity adjustments (I1, I2, I3) as follows:
X1=1
X2=1
X3=1
IF (I1>0.5) THEN X1=2*(1.0−I1)
IF (I2>0.5) THEN X2=2*(1.0−I2)
IF (I3>0.5) THEN X3=2*(1.0−I3)
F1=I1*X2*X3
F2=I2*X1*X3
F3=I3*X1*X2

A registration matrix 39 operates upon the NM volume for alignment of the voxels of the NM volume with corresponding voxels of the CT/MRI volume 32. In the example of FIG. 3, the coronary arteries are inherently aligned with the CT/MRI volume 32 by the binary mask so there is no need for a registration matrix to align the coronary arteries with the CT/MRI volume. However, additional volume images could be registered and blended into the fused volume image by providing an additional registration matrix for each additional volume. For instance, segmented coronary trees can be extracted from CT angio volumes different from CT volumes used for heart rendering. In that case two registration matrices will be utilized: CTA to CT and NM to CT. For user-selected rotation, pan, and zoom, a matrix 40 operates upon the combination from the registration matrix 39 with the color and intensity adjusted values from the CT/MRI volume 32 and from the coronary artery object 34. After adjustment by the matrix 40, the display 14 presents the fused image data to the user as a volume rendered image.

The fact that one of the input volumes is a segmented binary mask allows extended interactive features to be supported by the display. The segmented coronaries allow calculating and presenting separately coronary trees as a function of their cross-sections and orientations (e.g., a series of images showing the cross-sectional view of the vessels in the context of the cardiac tissue). A view angle exposing coronaries with most severe atherosclerotic lesions can be selected automatically or interactively. Correspondingly, a cross-section through the all fused volumes can be derived based on the local vessel orientation at the defect location.

The display also can be used in a dynamic fashion if matching dynamic or gated NM, CT, or MR studies are available. In that case each phase or time bin from each of the studies is used to render a single time point of the beating heart. A series of blended volume rendered images of the heart are sequenced together and displayed with modifiable rate.

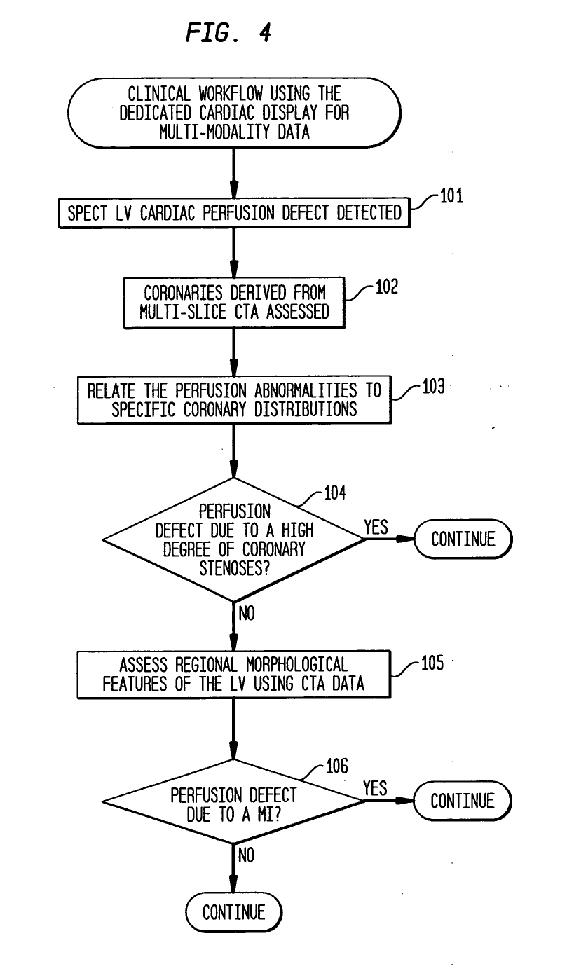

FIG. 4 shows an example of clinical workflow using the dedicated cardiac display for medical multi-modality data. The color-coding scheme (C1 in FIG. 3) selected for rendering the NM based portion of the image allows the user to identify cardiac perfusion or viability defects. The coronary artery objects can be accessed for degree of stenotic defects using the same image.

In a first step 101 of FIG. 4, for example, the user detects a SPECT left ventricle (LV) cardiac perfusion defect from the rendering of the NM based portion of the image. In step 102, the coronary artery objects derived from the multi-slice CTA volume are assessed. In step 103, the user rotates the displayed volume image so as to view specific coronary distributions associated with the perfusion abnormalities. In step 104, the user scrutinizes the displayed volume image to determine whether the perfusion defect is due to a high degree of coronary stenoses. If not, then in step 105, the user assesses regional morphological features of the left ventricle using the gated CT data. In step 106, based on the assessment of these regional morphological features, the user decides whether the perfusion defect is due to myocardial infarction (MI).

The main advantage of the clinical workflow in FIG. 4 is the fact that cardiac and cardiac related functional and morphological data is presented simultaneously, which can potentially increase accuracy and efficiency of the human decision making process.

While the invention has been described in detail above, the invention is not intended to be limited to the specific embodiments as described. It is evident that those skilled in the art may now make numerous uses and modifications of and departures from the specific embodiments described herein without departing from the inventive concepts.

What is claimed is:

1. A computer-implemented method comprising the steps of:
(a) obtaining cardiac image measurements of a patient from different imaging modalities to obtain volume image data of cardiac functional features from one imaging modality and volume image data of cardiac structural features from another imaging; and
(b) displaying, to a human user, a fused volume rendered view of the volume image data of the cardiac functional features and the volume image data of the cardiac structural features.

2. The method as claimed in claim 1, wherein said one imaging modality is a nuclear medicine (NM) scanner and the cardiac functional features include cardiac perfusion and viability defects, and said another imaging modality is selected from the group consisting of an X-ray computed tomography (CT) scanner and a magnetic resonance imaging (MRI) scanner.

3. The method as claimed in claim 1, wherein the cardiac structural features include at least one of the three main coronary arteries or sub-segments of at least one of the three main coronary arteries.

4. The method as claimed in claim 1, which further includes the step of automatically analyzing the volume image data of cardiac structural features to identify a particular cardiac structural feature and to indicate the location of the particular cardiac structural feature in the fused volume rendered view.

5. The method as claimed in claim 4, wherein the particular structural feature is at least a sub-segment of one of the three main coronary arteries, and the location of said at least a sub-segment of the one of the three main coronary arteries is indicated by displaying said at least a sub-segment of the one of the three main coronary arteries in a distinctive color.

6. The method as claimed in claim 1, which further includes responding to user input by adjusting color of the volume image data of cardiac functional features from said one imaging modality with respect to the volume image data of cardiac structural features from said another imaging modality in order to selectively differentiate the cardiac functional features from the cardiac structural features in the fused volume rendered view.

7. The method as claimed in claim 1, which further includes responding to user input by adjusting intensity of the volume image data of cardiac functional features from said one imaging modality with respect to the volume image data of cardiac structural features from said another imaging modality in order to selectively differentiate the cardiac functional features from the cardiac structural features in the fused volume rendered view.

8. The method as claimed in claim 1, which further includes responding to user input by selectively rotating, panning, and zooming the fused volume rendered view.

9. The method as claimed in claim 1, which further includes the user performing a diagnosis of cardiac disease upon viewing the fused volume rendered view by identifying cardiac perfusion abnormalities in the fused volume rendered view, relating the cardiac perfusion abnormalities to a specific coronary distribution, adjusting the fused volume rendered view for a showing of details of the specific coronary distribution, viewing the details of the specific coronary distribution, and diagnosing cardiac disease based on the details of the specific coronary distribution.

10. The method as claimed in claim 9, wherein the diagnosing of cardiac disease based on the details of the specific coronary distribution includes deciding whether the cardiac perfusion abnormalities are due to a high degree of coronary stenoses or due to myocardial infarction.

11. A system comprising a digital computer and a display coupled to the digital computer for display of image data processed by the digital computer, the digital computer being programmed for:
(a) obtaining cardiac image measurements of a patient from different imaging modalities to obtain volume image data of cardiac functional features from one imaging modality and volume image data of cardiac structural features from another imaging modality; and
(b) controlling the display for displaying, to a human user, a fused volume rendered view of the volume image data of the cardiac functional features and the volume image data of the cardiac structural features.

12. The system as claimed in claim 11, wherein said one imaging modality is a nuclear medicine (NM) scanner and the cardiac functional features include cardiac perfusion and viability defects, and said another imaging modality is selected from the group consisting of an X-ray computed tomography (CT) scanner and a magnetic resonance imaging (MRI) scanner.

13. The system as claimed in claim 11, wherein the cardiac structural features include one of the three main coronary arteries or sub-segments of one of the three main coronary arteries.

14. The system as claimed in claim 11, wherein the digital computer is further programmed for automatically analyzing the volume image data of cardiac structural features to identify a particular cardiac structural feature and to indicate the location of the particular cardiac structural feature in the fused volume rendered view.

15. The system as claimed in claim 14, wherein the particular structural feature is at least a sub-segment of one of the three main coronary arteries, and the digital computer is further programmed to indicate the location of said at least a sub-segment of the one of the three main coronary arteries by controlling the display to display said at least a sub-segment of the one of the three main coronary arteries in a distinctive color.

16. The system as claimed in claim 11, wherein the digital computer is further programmed for responding to user input by adjusting color of the volume image data of cardiac functional features from said one imaging modality with respect to the volume image data of cardiac structural features from said another imaging modality in order to selectively differentiate the cardiac functional features from the cardiac structural features in the fused volume rendered view.

17. The system as claimed in claim 11, wherein the digital computer is further programmed for responding to user input by adjusting intensity of the volume image data of cardiac functional features from said one imaging modality with respect to the volume image data of cardiac structural features from said another imaging modality in order to selectively differentiate the cardiac functional features from the cardiac structural features in the fused volume rendered view.

18. The system as claimed in claim 11, wherein the digital computer is further programmed for responding to user input by selectively rotating, panning, and zooming the fused volume rendered view.

19. A system comprising a digital computer and a display coupled to the digital computer for display of image data processed by the digital computer, the digital computer being programmed for:
(a) obtaining cardiac image measurements of a patient from a nuclear medicine (NM) scanner to obtain volume image data of cardiac perfusion and viability and obtaining cardiac image measurements of the patient from at least one of an X-ray computed tomography (CT) scanner or a magnetic resonance imaging (MR) scanner to obtain volume image data of cardiac structural features including coronary arteries;
(b) automatically analyzing the volume image data of the cardiac structural features to identify the coronary arteries;
(c) registering the volume image data of cardiac perfusion and viability with the volume image data of the cardiac structural features; and
(c) controlling the display for displaying, to a human user, a fused volume rendered view of the registered volume image data of the cardiac perfusion and viability and the volume image data of the cardiac structural features, and for displaying the coronaries and the volume image data of cardiac perfusion and viability in distinctive colors.

20. The system as claimed in claim 19, wherein the computer is programmed for automatically identifying the left anterior descending coronary artery, the circumflex coronary artery, and the right coronary artery, and for displaying each of the left anterior descending coronary artery, the circumflex coronary artery, and the right coronary artery in a distinctive color.

21. The system as claimed in claim 19, wherein the digital computer is further programmed for responding to user input for adjusting the distinctive colors of the coronaries and the volume image data of the cardiac perfusion and viability.

22. The system as claimed in claim 19, wherein the digital computer is further programmed for responding to user input for adjusting transparency in the fused volume image of the volume image data of the cardiac perfusion and viability, the volume image data of the cardiac structural features, and the display of the coronary arteries.

23. The system as claimed in claim 19, wherein the fused volume rendered view shows the patient's heart, and wherein the digital computer is programmed for responding to user input for rotating, panning, and zooming the fused volume rendered view so that the display shows details of a selected one of the left anterior descending coronary artery or sub-segments of the left anterior descending coronary artery, the circumflex coronary artery or sub-segments of the circumflex coronary artery, and the right coronary artery or sub-segments of the right coronary artery.
